(19) United States
(12) Patent Application Publication
(10) Pub. No.: US 2022/0089490 A1
(43) Pub. Date: Mar. 24, 2022

(54) BI-COMPONENT MICROFIBERS WITH HYDROPHILIC POLYMERS ON THE SURFACE WITH ENHANCED DISPERSION IN ALKALINE ENVIRONMENT FOR FIBER CEMENT ROOFING APPLICATION

(71) Applicants: Dow Global Technologies LLC, Midland, MI (US); Dow Brasil Sudeste Industrial Ltda., Sao Paulo/Sp (BR)

(72) Inventors: Eduardo Cruz, Sao Paulo (BR); Michael J. Radler, Saginaw, MI (US); Ana Cláudia Rueda Nery, Sao Paulo (BR); Prasanna K. Jog, Lansdale, PA (US); Gerald F. Billovits, Midland, MI (US); Jonathan D. Moore, Midland, MI (US); Thomas J. Parsons, Midland, MI (US)

(21) Appl. No.: 17/425,478

(22) PCT Filed: Mar. 24, 2020
(86) PCT No.: PCT/US2020/024408

§ 371 Date: Jul. 23, 2021

Related U.S. Application Data
(60) Provisional application No. 62/830,591, filed on Apr. 8, 2019.

(51) Int. Cl. C04B 20/10; C08L 23/12; C04B 16/06; C04B 28/02; C04B 14/28; C04B 18/24; D01F 8/10; D01F 8/06; D01F 6/46

(52) U.S. Cl. CPC C04B 20/1033; C08L 23/12; C04B 16/0633; C04B 28/02; C08L 2203/12; C04B 18/24; D01F 8/10; D01F 8/06; D01F 6/46; C04B 14/28

(57) ABSTRACT

The present invention provides bi-component core-shell polymeric microfibers for reinforcing concrete comprising as a first component (shell) ethylene-vinyl alcohol (EVOH) polymer and at least one plasticizer, preferably, polyethylene glycol, and as a second component (core) a polymer chosen from a polyamide, a polyester, such as polyethylene terephthalate, and a polymer blend of a polyolefin and an anhydride grafted polyolefin and having an aspect ratio of length to diameter (L/D) or equivalent diameter of from 300 to 1000. The bi-component polymeric microfibers comprise from 5 to 45 wt. % of the first component, are easily processed, and provide fiber cements having improved mechanical properties at relatively low microfiber loadings.

The present invention relates to bi-component polymeric microfibers for use in making fiber cement, the components having high adhesion to one another. More particularly, it relates to compositions of bi-component polymeric microfibers comprising an outer component, preferably, a shell, of ethylene-vinyl alcohol (EVOH) fiber and at least one plasticizer, and an olefin inner component or core comprising polypropylene grafted with maleic anhydride. Further, the present invention relates to wet fiber cement compositions containing the bi-component polymeric microfibers and hydraulic cements, and to fiber cement or cement fiberboards containing the bi-component polymeric microfibers.

Use of corrugated fiber cement tiles for roofing on residential and commercial buildings and cement fiberboards for exterior siding continues to grow, for example, in Latin America. Boards are composed of cement and fillers and are reinforced with fibers such as cellulosic, synthetic or asbestos where legislation allows. However, asbestos use has long been prohibited in developed countries because it presents an inhalation hazard. Currently, according to the International Ban Asbestos Secretariat (IBAS), the usage of asbestos fiber has been prohibited in 61 countries. Brazil recently banned asbestos in late 2017 which will greatly impact fiber cement tile use for roofing applications. Thus, there remains a need for alternatives to asbestos fiber in fiber cement tiles and in cement fiberboard.

Synthetic fibers available for asbestos replacement in air-cured fiber cement products include PP (polypropylene) and PVOH (poly-vinyl alcohol), which is hydrophilic by nature. PP fiber usage imposes some difficulties because of its hydrophobic nature; this impacts tile delamination, and fiber dispersibility or deformability in larger tiles. For adequate dispersibility, PP fibers require a post treatment, such as corona discharge or a surfactant bath; effective post treatment remains more challenging for smaller substrate nuclei or microfibers as opposed to macrofibers; and it requires, in the case of corona discharge, additional equipment and process complexity. Accordingly, would be desirable to eliminate such post treatment methods.

Microfibers have more interfacial surface area than do macrofibers and can thus have a greater impact on spinning, and fiber formation of PP core containing fibers than macrofibers. For example, microfiber spinning has proven much more difficult than macrofiber spinning because such fibers are harder to extrude through smaller dies. Nevertheless, it remains desirable to provide cement fiberboards having microfibers because such microfibers also have a greater impact on cement fiberboard properties than do the equivalent proportion of macrofibers owing to the increase in interfacial surface area that they provide.

US20150133018 to Jog discloses bi-component fibers with EVOH on the surface for concrete reinforcement. A bi-component polymeric macrofiber composition for reinforcing concrete comprising as an outer component ethylene-vinyl alcohol (EVOH) polymer having from 5 mol % to 82.5 mol % of ethylene, and as a second component a polymer blend of polypropylene grafted with maleic anhydride and polypropylene or polyethylene. However, Jog fails to disclose or make microfibers and applications in fiber cement composites and fails to solve the problem of providing cement composites comprising reinforcing microfibers that are free of asbestos. Accordingly, there remains a need to provide useful cement composites with reliable microfiber reinforcement.

The present inventors have sought to solve the problem of providing asbestos-free reinforcing fibers for cement fiberboard that have good dispersibility, which are made and used in a practical manner, and which enable users to further improve the crack resistance and tensile strength of, for example, fiber cement.

### STATEMENT OF THE INVENTION

The present invention provides bi-component polymeric microfibers having a core shell structure with an ethylene-vinyl alcohol (EVOH) polymer shell and an olefin, polyamide or polyester core, and which are highly dispersible in fiber cement compositions as well as wet cement compositions for making cement fiberboard.

The preferred bi-component fiber of the present invention comprises a microfiber comprising polypropylene (PP) in a core and maleated PP (PP-g-MAH) in the core, which is a blend of both materials in the core and an ethylene vinyl alcohol (EVOH) outer layer or shell that reacts through esterification with the PP(PP-g-MAH) to keep both layers adhered. The preferred bi-component fiber of the present invention has equivalent diameter of <0.3 mm or less than 30 microns) per ASTM D7580/D7580M (2015). The preferred bi-component fiber of the present invention have an aspect ratio of length to diameter (L/D) or equivalent diameter of from 300 to 1000.

In the preferred bi-component fiber of the present invention, the (EVOH) polymer has from 30 mol % to 50 mol %, or, preferably, from 38 to 48 mol % of ethylene.

In the first component or shell of the preferred bi-component fiber of the present invention, the EVOH polymer comprises ethylene vinyl acetate polymers wherein the vinyl acetate portion is 85% or more hydrolyzed, or, preferably, 97% or more hydrolyzed or, more preferably, fully hydrolyzed.

The preferred bi-component fiber of the present invention comprises in the outer component at least one plasticizer, preferably, a polyalkylene glycol, a methoxypolyalkylene glycol, or their admixture, or, more preferably, polyethylene glycol (PEG).

In the preferred bi-component fiber of the present invention, the first component or shell has a total amount of the plasticizer ranges from 0.75 to 15 wt. %, or, preferably, from 1 to 10 wt. %, or, more preferably, from 1.5 to 7.5 wt. %, all weight percentages based on the total weight of the first component of the bi-component polymeric microfiber.

The preferred bi-component fiber of the present invention comprises in the second component or core a polymer blend of a polyolefin and an anhydride grafted olefin polymer, or more preferably, an ethylenically unsaturated anhydride grafted olefin polymer, wherein the unsaturated anhydride is chosen from maleic anhydride, itaconic anhydride, and fumaric anhydride, or, more preferably, maleic anhydride.

In the preferred bi-component fiber of the present invention, the second component (core) to first component (shell) ratio ranges from 55 to 95 wt. % to 5 to 45 wt. % (or from 95:5 to 55:45), or, preferably, from 60 to 90 wt. % to from 10 to 40 wt. % (or from 60:40 to 90:10), or, more preferably, from 70 to 85 wt. % to from 15 to 30 wt. % (or from 70:30 to 85:15), all weights based on the total weight of microfiber solids.

The preferred bi-component fiber of the present invention comprises in the second component or core a polymer blend of a polypropylene polypropylene grafted with an ethylenically unsaturated anhydride, preferably, maleic anhydride, and the ethylenically unsaturated anhydride proportion ranges from 0.01 to 0.3 wt. %, or, preferably, from 0.02 to 0.15 wt. %. or, more preferably, from 0.02 to 0.08 wt. %, or, even more preferably, from 0.05 to 0.08 wt. % of maleic anhydride, even more preferably, from 0.05 to 0.08 wt. % of maleic anhydride based on the total weight of the polymer blend solids of the second component.

The most preferred bi-component fiber of the present invention comprises in the second component or core a polymer blend of a polypropylene and a maleic anhydride grafted polypropylene.

In a second aspect in accordance with the present invention, a composition comprises the preferred bi-component polymeric microfibers of the present invention for reinforcing concrete.

1. In a second aspect in accordance with the present invention, a composition of bi-component polymeric microfibers for reinforcing concrete comprises as an outer component or first component, preferably, a shell, ethylene-vinyl alcohol (EVOH) polymer having from 30 mol % to 50 mol % of ethylene, or, preferably, from 38 to 48 mol %, and at least one plasticizer, preferably, a polyalkylene glycol, a methoxypolyalkylene glycol, or their admixture, or, more preferably, polyethylene glycol (PEG), and as an inner component or second component, or core, a polymer chosen from a polyamide, a polyester, such as polyethylene terephthalate, or a polymer blend of, on one hand, a polyolefin, preferably, polypropylene (PP) or polyethylene, or, more preferably, polypropylene, and, on the other hand, an anhydride grafted polyolefin, preferably, polypropylene grafted with maleic anhydride (PP-g-MAH), wherein the bi-component polymeric microfibers have an aspect ratio of length to diameter (L/D) or equivalent diameter of from 300 to 1000.

2. In accordance with the composition of bi-component polymeric microfibers of item 1, above, wherein in the first component or shell the total amount of the plasticizer ranges from 0.75 to 15 wt. %, or, preferably, from 1 to 10 wt. %, or, more preferably, from 1.5 to 7.5 wt. %, all weight percentages based on the total weight of the first component of the bi-component polymeric microfibers.

3. In accordance with the composition of bi-component polymeric microfibers of any of items 1, or 2, above, wherein in the first component or shell, the EVOH polymer comprises ethylene vinyl acetate polymers wherein the vinyl acetate portion is 85% or more hydrolyzed, or, preferably, 97% or more hydrolyzed or, more preferably, fully hydrolyzed.

4. In accordance with the composition of bi-component polymeric microfibers of any of items 1, 2 or 3, above, wherein the EVOH polymer has a melt flow rate (MFR) of from 6.4 to 38 g/10 min at 210° C., 2.16 Kg (ASTM D1238-13 (2013)) and, further wherein the second component or core comprises the polymer blend wherein the polyolefin is a polypropylene having a melt flow rate of from 12 to 24 or, preferably, from 15 to 21 g/10 min at 230° C. and 2.16 Kg (ASTM D1238-13 (2013)).

5. In accordance with the composition of bi-component polymeric microfibers of any of items 1, 2, 3 or 4, above, wherein the second component or core comprises a polymer blend of a polyolefin and an anhydride grafted olefin polymer, or preferably, an ethylenically unsaturated anhydride grafted olefin polymer, wherein the unsaturated anhydride is chosen from maleic anhydride, itaconic anhydride, and fumaric anhydride, or, more preferably, maleic anhydride.

6. In accordance with the composition of bi-component polymeric microfibers of any of items 1, 2, 3, 4, or 5, above, wherein the second component or core comprises a polymer blend of a polypropylene and a maleic anhydride grafted polypropylene.

7. In accordance with the composition of bi-component polymeric microfibers of any of items 1, 2, 3, 4, 5, or 6, above, wherein the second component or core is a polymer blend of a polypropylene polypropylene grafted with an ethylenically unsaturated anhydride, preferably, maleic anhydride, and the ethylenically unsaturated anhydride proportion ranges from 0.01 to 0.3 wt. %, or, preferably, from 0.02 to 0.15 wt. %. or, more preferably, from 0.02 to 0.08 wt. %, or, even more preferably, from 0.05 to 0.08 wt. % of maleic anhydride, even more preferably, from 0.05 to 0.08 wt. % of maleic anhydride based on the total weight of the polymer blend solids of the second component.

8. In accordance with the composition of bi-component polymeric microfibers of any of items 1, 2, 3, 4, 5, 6, or 7, above, wherein the bi-component polymeric microfibers comprise a second component (core) to first component (shell) ratio of from 55 to 95 wt. % to 5 to 45 wt. % (or from 95:5 to 55:45), or, preferably, from 60 to 90 wt. % to from 10 to 40 wt. % (or from 60:40 to 90:10), or, more preferably, from 70 to 85 wt. % to from 15 to 30 wt. % (or from 70:30 to 85:15), all weights based on the total weight of microfiber solids.

9. In accordance with the composition of bi-component polymeric microfibers of any of items 1, 2, 3, 4, 5, 6, 7, or 8, above, or any preferred bi-component fiber of the present invention, wherein the composition comprises a wet fiber cement composition of the bi-component polymeric microfibers, preferably, having EVOH as the first component or shell and as the second component or core a polymer blend of a polyolefin, preferably, polypropylene, with an ethylenically unsaturated anhydride grafted polyolefin, preferably maleic anhydride grafted polypropylene, and, further, comprises water, hydraulic cement, limestone aggregate and cellulosic fibers.

10. In accordance with the wet fiber cement composition of item 9, above, wherein the composition further comprises one or more of a filler, preferably, silica or clay, a thickener, a plasticizer, or a pigment or colorant.

11. In accordance with the wet fiber cement composition of any one of items 9, or 10, above, or any preferred bi-component fiber of the present invention, wherein the wet composition comprises from 0.05 wt. % to 3.0 wt. %, or, preferably, from 0.1 to 1.25 wt. %, or, more preferably, from 0.15 to 1.0 wt. % of the bi-component polymeric microfibers, as solids, based on the total weight of the wet composition.

12. In accordance with another aspect of the present invention, a fiber cement article comprises a composition of the preferred bi-component fiber of the present invention or bi-component polymeric microfibers of as an outer component or first component ethylene-vinyl alcohol (EVOH) polymer having from 32 mol % to 50 mol % of ethylene, or, preferably, from 38 to 48 mol %, and at least one plasticizer, preferably, a polyalkylene glycol a methoxypolyalkylene glycol, or, more preferably, polyethylene glycol (PEG), and as a second component a polymer chosen from a polyamide, a polyester, such as polyethylene terephthalate, and a polymer blend of, on one hand, a polyolefin, preferably, polypropylene or polyethylene, or, more preferably, polypropylene, and, on the other hand, an anhydride grafted polyolefin, preferably, polypropylene grafted with maleic anhydride and cured hydraulic cement.

13. In accordance with the fiber cement article of item 12, above, wherein the second component comprises a polymer blend of a polyolefin and an anhydride grafted olefin polymer, or preferably, an ethylenically unsaturated anhydride grafted olefin polymer, wherein the unsaturated anhydride is chosen from maleic anhydride, itaconic anhydride, and fumaric anhydride, or, more preferably, maleic anhydride.

14. In accordance with the fiber cement article of any one of items 12 or 13, above, wherein the article further comprises limestone aggregate and cellulosic fibers.

15. In accordance with the fiber cement article of item 14 above, wherein the article further comprises one or more of a filler, preferably, silica or clay, a thickener, a plasticizer, or a pigment or colorant

16. In accordance with yet another aspect of the present invention, a method of making the bi-component polymeric microfibers of any one of items 1 to 9, above, comprises co-extruding the first component and the second component without blending them.

17. In accordance with the method of item 16, wherein in co-extruding the fibers are shaped and drawn to an aspect ratio of length to diameter (L/D) or equivalent diameter of from 300 to 1000, or, preferably, from 450 to 700.

Unless otherwise indicated, conditions of temperature and pressure are ambient temperature and standard pressure. All ranges recited are inclusive and combinable.

Unless otherwise indicated, any term containing parentheses refers, alternatively, to the whole term as if no parentheses were present and the term without them, and combinations of each alternative. Thus, the term “(poly)ethylene glycol” refers to ethylene glycol, polyethylene glycol or their mixtures.

All ranges are inclusive and combinable. For example, the term “a range of from 0.06 to 0.25 wt. %, or, preferably, from 0.06 to 0.08 wt. %” would include each of from 0.06 to 0.25 wt. %, from 0.06 to 0.08 wt. %, and from 0.08 to 0.25 wt. %.

As used herein, the term “ASTM” refers to publications of ASTM International, West Conshohocken, Pa.

As used herein, the term “aspect ratio” or “L/D ratio” or “L/D” refers to the ratio of the total length of a cut fiber and its cross section width, with length as measured by sliding a small bundle of fibers into the slot of a fiber clamp and compressing the fibers by inserting into the slot the tab from the mating piece of the clamp so as to compress the fibers, followed by cutting the fibers by sliding a sharp blade across the surface of the clamp, then measuring the cross section of the fibers through optical microscopy with a digital camera. If the cross section of the fiber is not a perfect circle, the major and minor axis dimensions of the fiber are measured as in an ellipse and then an average is taken as the cross-sectional dimension or equivalent diameter. Fiber samples are chosen at random and the aspect ratio reported is the average of the equivalent diameter determined from twenty (20) randomly selected fibers.

As used herein, the term “fiber cement” is interchangeable with and means the same thing as “cement fiberboard” or “fiberboard”. However, as used herein, the term “wet fiber cement” refers to hydraulic binder compositions used to make fiber cement or fiberboard.

As used herein, the term “equivalent diameter” refers to an average cross-sectional diameter of a fiber as used in determining the aspect ratio of the fiber, i.e. the average cross section of the major and minor axes of the fiber where the fiber is not a perfect circle. Fiber samples are chosen at random and the equivalent diameter reported is the average of the equivalent diameter determined from twenty (20) randomly selected fibers.

As used herein, the term “diameter” refers to the diameter of microfiber having a round cross-section. Fiber samples are chosen at random and the diameter reported is the average of the diameter determined from twenty (20) randomly selected fibers.

As used herein, the term “macrofiber” means fiber which has an average linear density greater than or equal to 580 denier and an equivalent diameter of >0.3 mm or greater than or equal to 30 microns) per ASTM D7508/D7508M (2015) Standard Specification for Polyolefin Chopped Strands for Use in Concrete.

As used herein, the term “microfiber” means a fiber which has a linear density of less than 580 denier and an equivalent diameter of <0.3 mm or less than 30 microns) per ASTM D7580/D7580M (2015) Standard Specification for Polyolefin Chopped Strands for Use in Concrete.

As used herein, the term “polymer” includes homopolymers and copolymers that are formed from two or more different monomer reactants or that comprise two distinct repeat units.

As used herein, the term “surfactant” means a water dispersible organic molecule that contains both a hydrophilic phase, such as an oligoethoxylate, and a hydrophobic group or phase, such as C₈ alkyl or alkylaryl group.

As used herein, the term “total solids” refers to all materials in given composition aside from solvents, liquid carriers, unreactive volatiles, including volatile organic compounds or VOCs, ammonia and water.

As used herein, the term “weight average molecular weight” or MW refers to the weight average of the molecular weight distribution of a polymer or plasticizer material determined using gel permeation chromatography (GPC) of a polymer dispersion in water or an appropriate solvent for the analyte polymer or plasticizer at room temperature and using the appropriate conventional polyglycol, vinyl or styrene polymer standards.

As used herein, the term “weight average particle size” refers to the weight average of the particle size distribution particle size of an indicated material as determined by light scattering or another equivalent method.

As used herein, the phrase “wt. %” stands for weight percent.

The present invention provides bi-component microfibers and compositions containing them which are used as a reinforcement in fiber cement, wherein the adhesion between the second component or core and the outer or first component polymers, for example, between core and sheath or core and shell, improves fiber cement performance. In addition, the present invention enables a practical method for making the microfibers in accordance with the present invention. Further, because the ethylene-vinyl alcohol (EVOH) forms a strong bond with cement, the present invention allows one to make bi-component polymeric microfibers that improve the fiberboard containing them, such as in its ductility.

The present inventors discovered that, unlike with macrofibers having an equivalent diameter of from 300 to 1000 microns, microfibers having an equivalent diameter of from 10 to 29.5 microns pose a substantially greater difficulty with spinnability and gel formation. Because EVOH is a brittle and tough hydrophilic material, in contrast with macrofiber formation, running a microfiber spinning or extrusion process going with a desirable proportion of EVOH poses problems. Compositions of the EVOH material gelled during spinning or extrusion at 50/50 (w/w/) proportions of the first component and second component; further, the bi-component polymeric microfibers made from 50 wt. % of first component EVOH polymer compositions gave inadequate ductility for practical use and were not strong enough from a tensile strength standpoint. At desirable EVOH concentrations, for example, 20 wt. % of the total microfiber forming composition, development of a high enough viscosity to enable extrusion or spinning with its attendant smaller equivalent diameter posed a problem and the microfibers broke in process in the lower viscosity. So, either the microfibers were too brittle and gelled or formed globs on microfibers in processing or, when they had a lower EVOH content could not be processed. Accordingly, the present inventors discovered that addition of plasticizer in the first component shell forming EVOH composition enabled successful spinning to make bi-component polymeric microfibers having a 15 micron equivalent diameter and a sufficiently low proportion of EVOH or the first component proportion to insure adequate fiber ductility and tensile strength in use.

EVOH provides excellent dispersibility in an alkaline environment (pH 10-13) of a cementitious matrix. Further, EVOH allows good interaction or adhesion between the bi-component polymeric microfibers and the cement matrix, reaching the performance of polyvinyl alcohol (PVOH) fibers in use. Such adhesion between cement matrix and microfiber remains key for the fiber cement produced through the Hatschek process which requires dewatering of the composition without loss of materials aside from water. In the Hatschek process, the composition of microfibers, cement, any filler, such as silica, thickeners and limestone are dispersed in water in a solids concentration of from 150 to 200 g solids/liter before dewatering.

Additionally, in accordance with the present invention, the bi-component polymeric microfibers reinforcement for fiber cement enables improved dispersion and mechanical performance in microfiber containing compositions. For example, in accordance with the present invention, bi-component microfibers having an EVOH first component (shell) and a blend of PP and PP grafted with maleic anhydride as a second component (core) having a diameter of from 10 to 15 microns and a length of from 9 to 12 mm provided fiber cement composites with physicochemical properties better than existing asbestos free fiber cement composites (a.k.a. fiber cement NT) comprising polypropylene fibers

Suitable bi-component polymeric microfibers in accordance with the present invention have a second component of a polyamide core or a polymer blend of polypropylene (PP) which further comprises a PP grafted with maleic anhydride (PP-g-MAH).

The bi-component polymeric microfibers in accordance with the present invention can have a cross section of any shape, including, for example, circular, oval, ellipsoid, triangular, rhomboid, rectangular, square, polygonal (having more than 3 sides), limniscate, ribbon-like or filamentous, and polylobal.

Suitable bi-component polymeric microfibers have an aspect ratio or L/D ratio of from 300 to 1000, or, preferably, from 450 to 700. In one example, the bi-component polymeric microfibers have dimensions of 15 microns in equivalent diameter and 9 mm in length to give an L/D ratio of ˜600. Bi-component microfibers having a larger or smaller equivalent diameter can be longer or can be cut shorter to maintain a desired aspect ratio.

In accordance with the bi-component polymeric microfiber compositions of the present invention, one or more plasticizers, such as polyethylene glycol (PEG) in the shell or first component in combination with the EVOH polymer enable good spinnability at a first component/second component ratio suitable for forming the bi-component polymeric microfibers of the present invention.

Suitable plasticizers comprise polyalkylene glycols, such as polyethylene glycol (PEG) or polypropylene glycol (PPG) and methoxypolyalkylene glycols any of which have a weight average molecular weight MW of from 300 to 10,000, or, preferably, from 6000 to 9000. Preferably, in accordance with the present invention, the plasticizers comprise one or more polyethylene glycols (PEG).

In the bi-component polymeric microfibers and compositions used to make the microfibers of the present invention, the plasticizer makes up a part of the EVOH or first component. Suitable amounts of plasticizers comprise enough to enable spinning of the first component and yet not so much as to prevent the pressure buildup in an extruder, for example, necessary to form fibers.

The total amount of the plasticizer ranges from 0.75 to 15 wt. %, or, preferably, from 1 to 10 wt. %, or, more preferably, from 1.5 to 7.5 wt. %, all weight percentages based on the total weight of the first component of the bi-component polymeric microfibers.

In accordance with first component of the bi-component polymeric microfibers of the present invention, the polymer of the first component or shell comprises ethylene-vinyl alcohol (EVOH) polymer. Suitable EVOH polymers can comprise ethylene vinyl acetate polymers wherein the vinyl acetate portion is 85% or more, or, preferably, 97% or more or, more preferably, fully hydrolyzed.

The first component can comprise an ethylene-vinyl alcohol (EVOH) polymer having any molecular weight high enough to insure EVOH fiber formation, such as a weight average molecular weight (MW) as determined by Gel Permeation Chromatography using conventional vinyl or styrene polymer standards of 50,000 or higher, or, preferably, 70,000 or higher, and up to 10,000,000. It is not a wax.

The first component ethylene-vinyl alcohol (EVOH) polymer can comprise from 32 to 48 wt. % of ethylene, preferably, from 38 to 48 mol % of ethylene, based on the total solids weight of the EVOH polymer. If the amount of ethylene is too low, the EVOH polymer will be too water sensitive or absorbent and will have too strong an adhesion to concrete whereas fiber delamination from concrete is the desired failure mode. If the amount of ethylene is too high, the adhesion of the EVOH polymer to concrete and to the polymer of the second component will suffer.

In accordance with first component of the bi-component polymeric microfibers of the present invention, suitable EVOH polymers preferably comprise from 32 to 48 wt. % of ethylene, based on the total weight of reactants used to make the polymer.

To insure that the EVOH polymer in accordance with the first component or shell of the bi-component polymeric microfibers of the present invention flows well enough to enable fiber formation to make the bi-component polymeric microfibers, the EVOH has a melt flow rate (MFR) of from 6.4 to 38 g/10 min at 210° C., 2.16 Kg (ASTM D1238 13). Generally, the higher the ethylene content, the lower the MFR.

EVOH polymers having excessive amounts of vinyl alcohol repeat units are harder to process and may break when drawing fibers. Preferably, the ethylene-vinyl alcohol (EVOH) polymer in accordance with the present invention comprises from 30 to 48 wt. % of ethylene, based on the total weight of reactants used to make the polymer, such as 32 to 48 wt. % of ethylene, and has a vinyl acetate portion that is 85% or more hydrolyzed, or, preferably, 97% or more or, more preferably, fully hydrolyzed, has a melt flow rate (MFR) of from 6.4 to 38 g/10 min at 210° C., 2.16 Kg (ASTM D1238-13 (2013)). Such a suitable EVOH polymer is not a wax. Examples of suitable EVOH polymers include those with a 48 wt. % ethylene content and a MFR of 6.1 g/10 min at 210° C., 2.16 Kg, those with a 44 wt. % ethylene content and a MFR of 12 g/10 min at 210° C., 2.16 Kg and those with a 32% ethylene content and a MFR of 21 g/10 min at 210° C., 2.16 Kg.

The bi-component polymeric microfibers in accordance with the present invention provide optimal average residual strength (ARS) results and have as a second component or core an amide polymer, a polyester polymer, such as polyethylene terephthalate (PET), or a polymer blend of a polyolefin, preferably, polypropylene, and only a small amount of a polyolefin grafted with unsaturated anhydride in the polymer blend, preferably, the polymer blend, or, more preferably, polypropylene grafted with maleic anhydride.

In accordance with second component or core of the bi-component polymeric microfibers of the present invention comprises at least one polyamide, such as a polyhexamethyl adipamide, at least one polyester, such as polyethylene terephthalate (PET), or a polymer blend of, on one hand, a polyolefin, such as polypropylene (PP), polyethylene (PE) and, on the other hand, an anhydride grafted polyolefin chosen from ethylenically unsaturated anhydride grafted PP, ethylenically unsaturated anhydride grafted polyethylene (PE), such as anhydride-modified high density polyethylene (HDPE) resins, anhydride-modified linear low density polyethylene (LLDPE) resins, or anhydride-modified low density polyethylene (LDPE) resins, or, preferably, the polymer blend, or, more preferably, a polypropylene (PP) with an ethylenically unsaturated anhydride grafted PP, or, even more preferably, PP with maleic anhydride grafted PP.

Suitable polyolefins for use in the second component in accordance with the present invention include polypropylenes having a melt flow rate (MFR) of from 12 to 24 or, preferably, from 15 to 21 g/10 min at 230° C. and 2.16 Kg (ASTM D1238-13 (2013)). Low MFR polyolefins should be processed at higher temperatures.

Suitable anhydrides for use in making the anhydride grafted olefin polymer in accordance with polymer blend of the second component of the present invention are any ethylenically unsaturated anhydrides, such as maleic anhydride, itaconic anhydride, and fumaric anhydride, preferably, maleic anhydride.

In the second component polymer blend in accordance with the present invention, if the amount of grafted anhydride polymer is too low, the resulting microfibers will suffer from insufficient adhesion to the first component polymer; if the amount of grafted anhydride is too high, then the second component fiber forming polymer will be too cohesive to consistently form a microfiber; and will be unevenly or inconsistently distributed into the bi-component polymeric microfiber product.

In accordance with the polymer blend of the second component of the bi-component polymeric microfibers of the present invention, the ethylenically unsaturated anhydride used for grafting comprises a proportion of from 0.01 to 0.3 wt. %, or, preferably, from 0.01 to 0.2 wt. %, such as, preferably from 0.02 to 0.15 wt. %, of the unsaturated anhydride, for example, preferably, from 0.02 to 0.08 wt. %, or, more preferably, maleic anhydride in the amount of from 0.02 to 0.08 wt. % or, even more preferably, from 0.05 to 0.08 wt. % of maleic anhydride, all amounts based on the total weight of the polymer blend solids of the second component.

In accordance with polymer blend of the second component of the bi-component polymeric microfibers of the present invention, the polyolefin comprises from 80 to 99 wt. %, or, preferably, from 90 to 97 wt. %, based on the total weight of the polymer blend solids, and the graft polymer comprises the remainder of the polymer blend.

In accordance with the bi-component polymeric microfibers of the present invention, the second component (core) to first component (shell) ratio of from 55 to 95 wt. % to 5 to 45 wt. % (or from 95:5 to 55:45), or, preferably, from 60 to 90 wt. % to from 10 to 40 wt. % (or from 60:40 to 90:10), or, more preferably, from 70 to 85 wt. % to from 15 to 30 wt. % (or from 70:30 to 85:15), all weights based on the total weight of microfiber solids. In the preferred polymer blend of the second component or core in accordance with the present invention, the polymer blend comprises from 1 wt. % to 20 wt. %, or, preferably, from 3 to 10 wt. %, based on polymer blend solids, of unsaturated anhydride grafted olefin, such as polypropylene grafted with maleic anhydride (PP-g-MAH). In one example, core-shell bi-component polymeric microfibers with no PP-g-MAH in the core or second component, thereby comprising bi-component polymeric microfibers of PP (core) and EVOH (shell) failed to disperse properly or improve the ductility of fiber cement containing them. They exhibited no adhesion between the core and shell.

In another aspect, the present invention comprises wet fiber cement compositions useful in making cement fiberboards. In accordance with the fiber cement of the present invention, wet compositions comprise the bi-component polymeric microfibers further include the materials for forming fiber cements, such as a wet mixture of hydraulic cement, such as Ordinary Portland Cement, cellulose or cellulosic fiber, as sieve to retain solids in dewatering, such as from eucalyptus or pine wood, limestone or calcium carbonate and, if needed, thickeners or rheology modifiers.

In accordance with the dry solids of fiber cement compositions of the present invention suitable for making fiberboard, the compositions comprise from 0.15 to 3.0 wt. %, or, preferably, from 0.3 to 2.5 wt. %, or, more preferably, from 0.5 to 2.2 wt. % of bi-component polymeric microfiber solids, by weight. Water generally makes up one-half to two-thirds of the wet mixture for making fiberboard Accordingly, in accordance with the wet cement compositions of the present invention suitable for making fiberboard, the compositions comprise from 0.05 to 1.5 wt. %, or, preferably, from 0.1 to 1.25 wt. %, or, more preferably, from 0.15 to 1.0 wt. % of bi-component polymeric microfiber solids, by weight. Where the microfibers comprise more EVOH, which is denser than fibers of the second component, a greater weight percentage of the microfibers would be needed so that total microfiber volume can be kept constant. Accordingly, the bi-component polymeric microfibers of the present invention save on microfiber loading in fiber cement applications.

In accordance with the wet fiber cement compositions of the present invention, still other additives useful in the formation of concrete may be added, such as, for example, those known in the art. Examples include superplasticizers, water reducers, rheology modifiers, fume silica, furnace slag, air entrainers, corrosion inhibitors and polymer emulsions. To insure a homogeneous fiberboard product, fillers or additives should be 300 microns or smaller in weight average particle size. The wet fiber cement compositions in accordance with the present invention thus consist essentially of materials that have a weight average particle size of 300 microns or less.

In yet still another aspect in accordance with the present invention, methods of making the wet fiber cement compositions in accordance with the present invention, comprise mixing the hydraulic cement with the bi-component polymeric microfibers of the present invention for at least 10 seconds to at most 20 minutes to form a wet fiber cement composition, and curing, if desired, with heating. Preferably, the mixing time is at least 30 seconds, or, more preferably at least 1 minute and up to 10 minutes, or, most preferably from 1 to 5 minutes.

In yet another aspect in accordance with the present invention, methods of forming the bi-component polymeric microfibers comprise well-known processes, such as melt spinning or extrusion, wet spinning, or conjugate spinning. Any known fiber forming process will work so long as the process will melt the materials used to form the microfibers and thereafter not destroy the microfibers in process. In processing, the fibers are shaped, formed and drawn, such as by melt extrusion through a die to shape the fibers, and a spinneret to form elongated fibers which then may be drawn, such as around a set of rollers placed in tension to a specified aspect ratio of length to diameter (L/D) or equivalent diameter. Preferably, the bi-component polymeric microfibers can be drawn to an aspect ratio of from 300 to 1000. Accordingly, the amount of the more rigid first component in the bi-component polymeric microfibers remains limited to 45 wt. % or less, or, preferably, from 10 to 40 wt. %, or, more preferably, from 15 to 30 wt. %, based on the total solids weight of the bi-component polymeric microfibers.

Preferably, in accordance with the present invention the methods comprise co-extruding the first component and the second component and do not include blending vinyl alcohol polymers and anhydride, e.g. maleic anhydride (MAH), grafted polyolefin or polypropylene polymers. The polymers of the first component and of the second component react at the interface and form a chemical bond, thereby increasing the interlayer adhesion between the first component and the second component of the microfibers.

When the second component is a polymer blend in accordance with first component, the method of making the polymer blend comprises mixing the polymers that make up the polymer blend to form the second component prior to co-extruding, or it comprises masterbatching a portion of the anhydride grafted polyolefin larger than the amount thereof in the second component with a polyolefin to form a masterbatch, followed by melt blending the masterbatch with a polyolefin to form a melt of the second component.

Bi-component polymeric microfibers may be formed having a number of configurations having a core of the second component and a shell of the first component including, for example, core/sheath microfilament microfibers. For example, the bi-component polymeric microfibers of the present invention may be extruded into any size, shape or length desired. They may be extruded into any shape desired, such as, for example, cylindrical, cross-shaped, trilobal or ribbon-like cross-section. Regardless of their configuration, the bi-component polymeric microfibers of the present invention can have a cross section of any shape that accommodates both the second component and the first component as a microfiber with the first component on the outer portion of the fiber. For example, in bi-component polymeric microfibers having an islands in a sea configuration, a bi-component polymeric microfiber having a rounded cross section can accommodate more islands of the second component than bi-component polymeric microfibers having a ribbon cross section.

Core/shell bi-component polymeric microfibers those microfibers wherein the second component is fully surrounded the first component. The most common way to produce core/shell microfibers is a technique in which two polymer component melts are separately led to a position very close to the spinneret orifices and then extruded coaxially in core/shell form. In the case of concentric fibers, the orifice supplying the second component is in the center of the spinning orifice outlet and flow conditions of core polymer fluid are strictly controlled to maintain the concentricity of both components when spinning Modifications in spinneret orifices enable one to obtain different shapes of core or/and shell within the microfiber cross-section.

Other methods for producing core/sheath bi-component fibers are described in U.S. Pat. Nos. 3,315,021 and 3,316,336.

### EXAMPLES

The following examples are used to illustrate the present invention without limiting it to those examples. Unless otherwise indicated, all temperatures are ambient temperatures (21-23° C.) and all pressures are 1 atmosphere.

The inventive microfibers indicated in the Examples 1A, 2 and 3, below, the comparative polymer blend microfiber of Example 4, below, and the comparative bi-component polymer blend microfiber of Example 5, below, were extruded, formed and drawn via a melt spinning process. In the process, all indicated components were melted in an extruder, or, in the case of coextrusion, one component in each of two different extruders, and then pumped to a die that has plate designed to flow the one component, or in the case of two components, an inner and outer material in a bi-component core/shell configuration. Downstream of the die, the resulting fibers were drawn to a desired aspect ratio. The apparatus comprised Hills, Inc. (West Melbourne, Fla.) extruder equipment having a temperature profile of from 185-200° C., a flow through speed of 800 mpm, and a denier 5.9 den, wherein the extruder dies in the case of coextrusion were configured so that the second component flowed through a round die of 0.25 mm in diameter. In single component extrusion, the component flowed through a round die of 0.25 mm in diameter. A spinneret was located downstream of the co-extrusion equipment.

In coextrusion, the first component was co-extruded co-axially around the second component through an annular shaped die having an inner diameter matching the outer diameter of the round die. The spun fibers were then drawn to form bi-component polymeric microfibers having an average diameter of about 15 microns wherein the sheath of the first component formed an annulus of from 1 to 2 microns in thickness.

In extrusion, the one component was extruded through the round die and the spun fibers were then drawn to polymeric microfibers having an average diameter of about 15 microns.

Component proportions are indicated in the examples, below. Inventive proportions of the first component and second component of the bi-component polymeric microfibers were selected to target core/shell bi-component microfibers having an 80/20 ratio (w/w/) of second component or core to first component or shell. The first component EVOH was very difficult to extrude, shape and draw into a microfiber. Accordingly, the polyethylene glycol indicated in the examples below, was included in a melt of the first component; and the bi-component polymeric microfibers were produced via the melt spinning process. During extrusion the amounts of the first component and second component were varied in process to lower the proportion of the first component as much as possible. If possible, the proportion of the first component was lowered to 20 wt. % based on the total weight of bi-component polymeric microfiber solids. Where it was not possible to lower the first component proportion to 20 wt. %, the indicated proportion of the first component in the bi-component polymeric microfibers was the lowest proportion of first component obtained before the resulting microfibers would break upon drawing to form microfibers.

All fibers in the following Examples and Comparative Examples have an L/D of 600, a diameter of 15 micron, and a length of 9 mm.

The materials used in examples are, as follows:

Ethylene vinyl alcohol copolymer or EVOH: SOARNOL™ A4412 ethylene vinyl alcohol copolymer having a 44 mol % ethylene content, a melt flow rate (MFR) of 12 g/10 min (210° C., 2.16 Kg via melt index tester), a density (Micromeritics Gas Pycnometer, Micromeritics Instrument Corp., Norcross, Ga.) of 1.14 g/cm³ at 23° C. and a melting point of 164° C. (DSC heating and cooling speeds of 10° C./min) (Soarus LLC, Arlington Heights, Ill.).

Polyethylene glycol or PEG: MW of 7000 to 9000, density 1.07 (g/cm³; 70° C.); heat of fusion 41 (Cal/g); average number of repeating oxyethylene units 181.

Maleic anhydride grafted polypropylene or PP-g-MAH: POLYBOND™ 3150 maleic anhydride grafted polypropylene having a maleic anhydride content of from 0.7 wt. %, a melt flow rate (MFR) of 52 g/10 min (230° C., 2.16 Kg via melt index tester) and a density 0.91 g/cm³ at 23° C. (Addivant corporation, Danbury, Conn.). Various PP-g-MAH materials and their polymer blends are given in Tables 2A and 2B, below.

Polypropylene or PP: Polypropylene D180M PP having a MFR of 18 g/10 min at 230° C., 2.16 Kg (Braskem USA, Philadelphia, Pa.). Having a melting point MP (DSC) of 160° C., a density of 0.905 g/cc and an MFR of 18 g/10 min at 230° C., 2.16 Kg. Various PP materials and their polymer blends are given in Table 2, below.

Polyvinyl alcohol (PVOH) microfibers: High tenacity and high modulus PVA fiber W1 6 mm from Anhui Wanwei Updated Hightech Material Industry Co. Ltd., Chao hu, Anhui, China. PVOH fiber properties are presented in Table 1, below.

PP microfibers: PP monofilament 1.10 dtex×9 mm (Saint Gobain do Brasil Produtos Ind. e para const. Ltda-Brasilit Cia.). The PP fiber properties are presented in Table 2A, below.

MB2: The composition shown in Table 2B, below, was prepared by extrusion in a 26 mm twin screw extruder (44 L/D and 30 HP) having eleven (11) barrels and equipped with a 3 mm, 2 hole strand type die. Pellets of each of PP and PP-g-MAH were fed into the extruder using Ktron™ single screw feeders (Coperion GmbH, Stuttgart, Del.). The materials were fed into the main feed throat (barrel #1) with nitrogen gas in the feed throat. The strands were run through a 3.048 meter water bath and were pelletized using a Conair strand cutter (Conair, Stamford, Conn.). The total feed rate was 18.14 Kg/hr, and at a screw speed of 300 RPM. The temperature set points were 60° C. in zone 1 of barrel #2 and 180° C. in the remaining zones.

TABLE 1
PVOH fiber properties

| Properties | value |
|---|---|
| Linear density (dtex) | 2 |
| Tenacity (cN/dtex) | 12.2 |
| Elongation (%) | 6.8 |
| Hot water solubility (90° C., 1 h) | 0.7 |
| Dispersion grade (class) | 1 |
| Length (mm) | 6 |

TABLE 2A
PP fiber properties

| | | |
|---|---|---|
| Properties | value | specification |

| | | | | |
|---|---|---|---|---|
| Title | 1.12 | dtex | ≤1.20 | dtex |
| Tenacity | 10.18 | cN/dtex | ≥9.50 | cN/dtex |

| | | |
|---|---|---|
| Elongation | 19.42% | ≤25% |
| Moisture content | 2% | 1.5-2.5% |
| Finishing content | 0.68% | 0.6-0.7% |
| Dispersion grade | 3 | level 2 to 3 |

TABLE 2B
Second Component

| | Second Component |
|---|---|
| MB2 Composition | Composition |

| | | | |
|---|---|---|---|
| 80 wt. % | PP | 75 wt. % | PP |
| 20 wt. % | PP-g-MAH | 25 wt. % | MB2 |

TABLE 2C
Second Component Acid Content

| Material | Acid content (wt. %) |
|---|---|
| MB2 | 0.14 |
| Second Component | 0.035 |
| If second component diluted down 3× | 0.012 |
| with neat PP | |

Test Methods:

The following test methods were used in evaluating the Examples. The indicated aqueous dispersions of each of the indicated bi-component polymeric microfibers were tested for dispersibility in water. Separately, the bi-component polymeric microfibers indicated in the examples C1, C2, 1A, 2, 3, 4, and 5, below, were made into cement fiberboards by the methods given above and were tested for mechanical properties.

Dispersibility was assessed by stirring the 0.02 g of the indicated bi-component polymeric microfibers for 3 min in 1 liter of alkaline water (pH=10-11, ammonium OH) then filtering it through a black polyester cloth (for contrast) by pulling with vacuum (200 to 300 mmHg). Then the solution was poured over a Buchner funnel having upstream of the porous plate filter paper (Whatman, 80 g/cm², 10 cm diameter, Merck Millipore, Burlington, Mass.), and dark fabric (to enable visual evaluation). After removing the water, the patterns made by the fibers were assessed to evaluate their dispersibility. Fiber dispersibility was visually ranked with the following rating scale, as follows:

Grade 1: (completely dispersed) Microfibers are distributed homogeneously throughout the area of the filter paper, no clumped fibers;

Grade 2: 5-10 wt. % of the microfibers are clumped after filtering test;

Grade 3: 20-30 wt. % of the microfibers are clumped after filtering test;

Grade 4: (poor dispersibility) A majority of microfibers are clumped; poor bad distribution over the area of the filter paper.

Dispersibility results are reported on Table 3, below.

Mechanical Properties: Cement fiberboards were made using the wet compositions of bi-component polymeric microfibers in the manner indicated in each Example, below. Upon completing the curing period, fiber cement boards were cut (160 mm×40 mm×5 mm) and mechanical properties were assessed according to RILEM 49 TFR: testing method for fiber reinforced cement based composites, France, (1984). Specifically, a stress strain curve was generated by tensile testing the indicated fiber cement board using an INSTRON™ 5565 load testing machine (Instron, Norwood, Mass.), equipped with a 5 kgf load cell and a 5 mm/min load ratio on four steel cylindrical bending points, upper distance between point is 45 mm and lower distance between points is 135 mm, wherein two are placed centered on a stage underneath the cement fiberboard and flush to each edge of the underside of the 40 mm width of the fiberboard; and the two other bending points are placed underneath the stage a distance L mm apart so that the load cell is centered between each pair of bending points. The tensile tests generated a stress-strain curve from which the various mechanical properties were derived. Mechanical results can be found below in Table 4, below.

Stress-strain curve: Microfiber containing cement fiberboards that were made according to the indicated examples were subjected to mechanical testing by varying the stress, load or force generated on them and measuring the strain caused by each level of stress. The tests were used to generate a stress strain curve. obtained from the stress-strain curve during the tensile strength test.

Obtained from the stress-strain curve generated during the tensile test, the MOR or modulus of rupture is reported as the maximum stress supported by the composite matrix during the stress-strain test and is calculated with the ultimate load achieved during the test divided by the area of the fiberboard specimen. MOR is given by Equation 1, below, and is the average result reported from five (5) cement fiberboards selected at random. An acceptable modulus of rupture is at least 2.0 MPa, or preferably, at least 3.0 MPa.

$$MOR = \frac{{F}_{2} * L}{b * {d}^{2}} \qquad ( Equation 1 )$$

Where:

F₂, is the maximum load applied in N;

L, is the largest distance in mm between two lower load bearing points where the indicated cement fiberboard is placed onto two load bearing points across its width, which points are centered on top of a wider load bearing member that is supported by the two lower load bearing points;

b, is the cement fiberboard width in mm;

d, is the cement fiberboard thickness in mm.

Obtained from the stress-strain curve generated during the tensile test, the limit of proportionality (LOP) is the area corresponding to the elastic deformation in the stress-strain plot and is proportional to the applied load. LOP is calculated with the load at which the load-strain curve deviates from linearity, the beginning of the plastic deformation regime, Equation 2, below. An acceptable limit of proportionality is at least 2.0 MPa, or preferably, at least 2.5 MPa.

$$LOP = \frac{{F}_{1} * L}{b * {d}^{2}} \qquad ( Equation 2 )$$

Where:

F₁, is the load applied in LOP in N;

L, is the largest distance in mm between two lower load bearing points where the indicated cement fiberboard is placed onto two load bearing points across its width, which points are centered on top of a wider load bearing member that is supported by the two lower load bearing points;

b, is the sample width in mm;

d, is the sample thickness in mm.

Obtained from the stress-strain curve generated during the flexural deformation test, the Modulus of Elasticity (MOE) or Young's Modulus is calculated as the slope of the stress-strain curve in the elastic deformation regime (see Callister, D. W., Rethwish G. D., Materials Science and Engineering: An Introduction, 8th ed., John Wiley & Sons Inc., chapter 6, p. 157, 2012).

The higher the MOE, the greater the cement fiberboard stiffness and the lower its elastic deformation, where the stress is proportional to the deformation. An acceptable modulus of elasticity is at least 2.5 GPa.

Obtained from the stress-strain curve generated during the flexural deformation test, the Specific energy (SE) is defined as the energy absorbed during the stress-strain test and is calculated by integral of the area under the curve load vs strain, see Equation 3, below. The higher the SE value, the better the fiber reinforcement ability. An acceptable specific energy is at least 2.5 kJ/m², or preferably, at least 3.5 kJ/m².

$$SE = \frac{Energy absorbed}{b * d} \qquad ( Equation 3 )$$

Where:

Energy absorbed is calculated as above.

b, is the sample width in mm;

d, is the sample thickness in mm.

### Comparative Example 1 (C1): Polyvinyl Alcohol (PVOH) Microfibers

As a reference standard, cement fiberboards were prepared with PVOH microfibers and then assessed. A cement fiberboard was prepared by dispersing ordinary Portland cement (64 wt. %), limestone (31.1 wt. %), cellulose fiber (3 wt. %) and PVOH fiber (1.9 wt. %) in water. After that, water was removed by a dewatering process using a molding chamber and applying vacuum (200-300 mmHg). Fiber cement boards were cast in 4 layers. Each layer was pressed for 2 min at 3.2 MPa. At the end, one layer is placed on top of the other. The resulting board was finally pressed for 5 min at 3.2 MPa. This process roughly mimics the Hatschek process. Fiber cement boards were then “plastic sealed” (wrapped) in polyvinylidene fluoride wrap and left in oven for 24 h at 50° C.; after this period, the cement fiberboard was removed from the oven and let sit at room temperature (6 d/23±2° C.) for curing. Upon completing the curing period, fiber cement boards were cut (160 mm×40 mm×5 mm) and mechanical properties were assessed.

### Comparative Example 2 (C2): Polypropylene (PP) Microfibers

Another reference standard, cement fiberboards were prepared with PP microfibers. The cement fiberboard was prepared by dispersing cement (64 wt. %), limestone (31.1 wt. %), cellulose fiber (3 wt. %) and PP fiber (1.4 wt. %) in water. After that, water was removed by dewatering process using a molding chamber and applying vacuum (200-300 mmHg). Fiber cement boards were cast in 4 layers. Each layer was pressed for 2 min at 3.2 MPa. At the end, one layer is placed on top of the other. The resulting board was finally pressed for 5 min at 3.2 MPa. Fiber cement boards were then wrapped in polyvinylidene fluoride wrap and left in an oven for 24 h at 50° C.; after this period the product was removed from the oven and let at room temperature (6 d/23±2° C.) for curing. Upon completing the curing period, fiber cement boards were cut (160 mm×40 mm×5 mm) and mechanical properties were assessed.

### Example 1: PP+PP-g-MAH Core/EVOH Shell Microfiber

A bi-component polymeric microfiber (second component PP+PP-g-MAH and first component EVOH) ratio 60/40 was prepared by co-extruding both polymer components in the melt extrusion process disclosed above. After collecting, fibers were post drawn 2.5× to achieve high polymer orientation and final tenacity, then continuous filament was cut in 9 mm lengths, diameter 25 microns and a L/D of 360 for dispersion tests.

### Example 1A: PP+PP-g-MAH Core/EVOH Shell Microfiber with 5 wt. % Shell PEG Plasticizer Content and Cement Fiberboard with 1.9 wt. % of the Microfiber

A bi-component polymeric microfiber (second component as core PP+PP-g-MAH and, as the first component, EVOH with PEG 5 wt. % of first component) was prepared by co-extruding both polymer components in the melt extrusion process disclosed above. After collecting, fibers were post drawn 4.5-5.0× to achieve high polymer orientation and final tenacity, then continuous filament was cut in 9 mm lengths and a L/D of 600 for fiber cement application tests. Cement fiberboard was prepared with PP+PP-g-MAH/EVOHP fibers (1.9%) fibers by dispersing ordinary Portland cement (64%), limestone (31.1%), cellulose fiber (3%) and PP+PP-g-MAH/EVOH fibers (1.9%) in water. After that, water was removed by dewatering process using a molding chamber and applying vacuum (200-300 mmHg). Fiber cement boards were cast in 4 layers. Each layer was pressed for 2 min at 3.2 MPa. At the end, one layer is placed on top of the other. The resulting board was finally pressed for 5 min at 3.2 MPa. Fiber cement boards were then wrapped in polyvinylidene fluoride wrap and left in an oven for 24 h at 50° C.; after this period, the cement fiberboard was removed from the oven and left at room temperature (6 d/23±2° C.) for curing. Upon completing the curing period, fiber cement boards were cut (160 mm×40 mm×5 mm) and their mechanical properties assessed.

### Example 2: PP+PP-g-MAH Core/EVOH Shell Microfiber with 5 wt. % Shell PEG Plasticizer Content and Cement Fiberboard with 1.4 wt. % of the Microfiber

A bi-component microfiber in accordance with the present invention (second component as core PP+PP-g-MAH and as first component EVOH with PEG 5 wt. % of first component) was prepared by co-extruding both polymers components in the melt extrusion process disclosed above. After collecting, fibers were post drawn 4.5-5.0× to achieve high polymer orientation and final tenacity, then continuous filament was cut in 9 mm lengths and an L/D of 600 for fiber cement application tests. Cement fiberboard was prepared by dispersing ordinary Portland cement (64 wt. %), limestone (31.1 wt. %), cellulose fiber (3 wt. %) and PP+PP-g-MAH/EVOHP fibers (1.4 wt. %) in water. After that, the water was removed by dewatering process using a molding chamber and applying vacuum (200-300 mmHg). Fiber cement boards were cast in 4 layers. Each layer was pressed for 2 min at 3.2 MPa. At the end, one layer is placed on top of the other. The resulting board was finally pressed for 5 min at 3.2 MPa. Fiber cement boards were then wrapped in polyvinylidene fluoride wrap and left in an oven for 24 h at 50° C.; after this, the product was removed from the oven and let sit at room temperature (6 d/23±2° C.) for curing. Upon completing the curing period, fiber cement boards were cut (160 mm×40 mm×5 mm) and their mechanical properties assessed.

### Example 3: PP+PP-g-MAH Core/EVOH Microfiber with 2.5 wt. % Shell Plasticizer Content 0.5 wt. % and Cement Fiberboard with 1.9 wt. % of the Microfiber

A bi-component microfiber in accordance with the present invention (second component as core PP+PP-g-MAH and as first component, EVOH+PEG 2.5 wt. % of first component) prepared by co-extruding both polymers components in the melt extrusion process, disclosed above. After collecting, fibers were post drawing 4.5-5.0× to achieve high polymer orientation and final tenacity, then continuous filament was cut in 9 mm length and L/D of 600 for fiber cement application tests. Fiber cement composites were prepared with PP+PP-g-MAH/EVOHP microfibers (1.9 wt. %) by dispersing cement (64 wt. %), limestone (31.1 wt. %), cellulose fiber (3 wt. %) and PP+PP-g-MAH/EVOHP fibers (1.9 wt. %) in water. After that, water was removed by dewatering process using a molding chamber and applying vacuum (200-300 mmHg). Fiber cement boards were cast in 4 layers. Each layer was pressed for 2 min at 3.2 MPa. At the end, one layer is placed on top of the other. The resulting board was finally pressed for 5 min at 3.2 MPa. Fiber cement boards were then wrapped in polyvinylidene fluoride wrap and left in an oven for 24 h at 50° C.; after this period the product was removed from the oven and let sit at room temperature (6 d/23±2° C.) for curing. Upon completing the curing period, fiber cement boards were cut (160 mm×40 mm×5 mm) and their mechanical properties assessed.

### Comparative Example 4: PP/PP-g-MAH Polymer Blend Microfibers

A bi-component microfiber in accordance with the present invention core PP and shell (PP-g-MAH) was prepared by co-extruding both polymer components in the melt extrusion process, disclosed above. After collecting, fibers were post drawing 4.5-5.0× to achieve high polymer orientation and final tenacity, then continuous filament was cut in 9 mm length and an L/D of 600 for fiber cement application tests. Cement fiberboards were prepared by dispersing cement (64 wt. %), limestone (31.1 wt. %), cellulose fiber (3 wt. %) and PP/PP-g-MAH fibers (1.4 wt. %) in water. After that, water was removed by dewatering process using a molding chamber and applying vacuum (200-300 mmHg). Fiber cement boards were cast in 4 layers. Each layer was pressed for 2 min at 3.2 MPa. At the end, one layer is placed on top of the other. The resulting board was finally pressed for 5 min at 3.2 MPa. Fiber cement boards were then wrapped in polyvinylidene fluoride wrap and left in an oven for 24 h at 50° C.; after this period, the product was removed from the oven and let sit at room temperature (6 d/23±2° C.) for curing. Upon completing the curing period, fiber cement boards were cut (160 mm×40 mm×5 mm) and their mechanical properties assessed.

### Comparative Example 3: PP+PP-g-MAH/EVOH (w/o Plasticizer) Fiber Cement Board with 1.9% of the Microfiber

A bi-component microfiber in accordance with the present invention (core PP and shell (PP-g-MAH) was prepared by co-extruding both polymer components in the melt extrusion process, disclosed above. After collecting, fibers were post drawing 2.5× to achieve high polymer orientation and final tenacity, then continuous filament was cut in 9 mm length and final diameter was 24.1 micron, an L/D of 370 for fiber cement application tests. Cement fiberboards were prepared by dispersing cement (64 wt. %), limestone (31.1 wt. %), cellulose fiber (3 wt. %) and PP/PP-g-MAH fibers (1.9 wt. %) in water. After that, water was removed by dewatering process using a molding chamber and applying vacuum (200-300 mmHg). Fiber cement boards were cast in 4 layers. Each layer was pressed for 2 min at 3.2 MPa. At the end, one layer is placed on top of the other. The resulting board was finally pressed for 5 min at 3.2 MPa. Fiber cement boards were then wrapped in polyvinylidene fluoride wrap and left in an oven for 24 h at 50° C.; after this period, the product was removed from the oven and let sit at room temperature (6 d/23±2° C.) for curing. Upon completing the curing period, fiber cement boards were cut (160 mm×40 mm×5 mm) and their mechanical properties assessed.

TABLE 3
Dispersibility in water

| | | Result |
|---|---|---|
| Example | Bi-component polymeric microfibers | (Grade) |
| C1* | PVOH | 1 |
| C2* | PP | 3 |
| 1 | core (PP + PP-g-MAH) and shell EVOH | 1 |

*Denotes Comparative Example.

As shown in Table 3 above, the inventive bi-component microfibers of Example 1 exhibit the same excellent dispersibility in water the PVOH microfibers of Comparative Example 1 and dramatically outperform the PP microfibers of Comparative Example 2.

TABLE 4
Mechanical Testing Performance

| | | Microfiber | Core/ | MOR | LOP | SE | MOE |
|---|---|---|---|---|---|---|---|
| Example | Material | loading | Shell ratio | (MPa) | (MPa) | (kJ/m²) | (GPa) |
| C1* | PVOH | 1.9 wt. % | n/a | 7.46 | 3.71 | 6.58 | 9.67 |
| C2* | PP | 1.4 wt. % | n/a | 4.43 | 2.67 | 4.74 | 3.80 |
| 1A | PP + PP-g- | 1.9 wt. % | 80/20 | 5.48 | 3.29 | 5.88 | 4.57 |
| | MAH/ | | | | | | |
| | EVOH (5 | | | | | | |
| | wt. % PEG) | | | | | | |
| 2 | PP + PP-g- | 1.4 wt. % | 80/20 | 4.49 | 3.04 | 4.72 | 4.76 |
| | MAH/ | | | | | | |
| | EVOHP (5 | | | | | | |
| | wt. % PEG) | | | | | | |
| 3 | PP + PP-g- | 1.9 wt. % | 80/20 | 4.21 | 2.67 | 4.57 | 2.54 |
| | MAH/ | | | | | | |
| | EVOHP | | | | | | |
| | (2.5 wt. % | | | | | | |
| | PEG) | | | | | | |
| 4* | PP/PP-g- | 1.4 wt. % | 80/20 | 4.19 | 2.29 | 4.37 | 3.48 |
| | MAH | | | | | | |
| 5* | PP + PP-g- | 1.9 wt. % | 50/50 | 3.57 | 2.93 | 2.45 | 4.36 |
| | MAH/ | | | | | | |
| | EVOH (w/o | | | | | | |
| | plasticizer) | | | | | | |

*Denotes Comparative Example.

As shown in Table 4, above, the inventive bi-component polymeric microfibers in Examples 1A, 2 and 3 demonstrated good mechanical properties, as did the polymeric microfibers of Comparative Examples C1, C2 and 4. The Mechanical properties of the inventive bi-component polymeric microfibers in Examples 1A, 2 and 3 demonstrated superior mechanical properties compared to the bi-component polymeric microfibers of Comparative Example 5 because they comprised a higher proportion of the core second component than the comparative bi-component polymeric microfibers. In addition, the inventive bi-component polymeric microfibers in Examples 1A, 2 and 3 demonstrated excellent processability and spinnability unlike those of Comparative Example 5 which could not be processed at an EVOH level below 50 wt. % of the bi-component polymeric microfiber solids which would lead to inadequate ductility. Further, the inventive bi-component polymeric microfibers in Example 2 demonstrated improved mechanical properties compared to the same polymeric microfibers of Comparative Example 4 without the first component. It was not expected that one could make microfibers having an EVOH sheath, much less bi-component polymeric microfibers having mechanical properties that were superior to the same microfibers without EVOH.

1. A composition comprising bi-component polymeric microfibers for reinforcing concrete having as an outer or first component or shell ethylene-vinyl alcohol (EVOH) polymer having from 30 mol % to 50 mol % of ethylene, and at least one plasticizer, and as a second component or core a polymer chosen from a polyamide, a polyester, and a polymer blend of, on one hand, a polyolefin, and, on the other hand, an anhydride grafted polyolefin, the bi-component polymeric microfibers having an aspect ratio of length to diameter (L/D) or equivalent diameter of from 300 to 1000.

2. The composition of bi-component polymeric microfibers as claimed in claim 1, wherein the at least one plasticizer is a polyalkylene glycol, a methoxypolyalkylene glycol, or their admixture, and, wherein the microfibers have an equivalent diameter of <0.3 mm or less than 30 microns per ASTM D7580/D7580M (2015).

3. The composition of bi-component polymeric microfibers as claimed in claim 1, wherein in the first component the total amount of the plasticizer ranges from 1 to 10 wt. %, based on the total weight of the first component of the bi-component polymeric microfibers.

4. The composition of bi-component polymeric microfibers as claimed in claim 1,
wherein the second component comprises a polymer blend of a polyolefin and an ethylenically unsaturated anhydride grafted olefin polymer.

5. The composition of bi-component polymeric microfibers as claimed in claim 1, wherein the second component comprises a polymer blend of a polypropylene and a maleic anhydride grafted polypropylene.

6. The composition of bi-component polymeric microfibers as claimed in claim 1, wherein the second component is a polymer blend of a polypropylene and polypropylene grafted with maleic anhydride, and the maleic anhydride proportion ranges from 0.01 to 0.3 wt. %, based on the total weight of the polymer blend solids of the second component.

7. The composition of bi-component polymeric microfibers as claimed in claim 1, wherein the EVOH polymer has a melt flow rate (MFR) of from 6.4 to 38 g/10 min at 210° C., 2.16 Kg (ASTM D1238-13 (2013) and, further wherein the second component comprises the polymer blend wherein the polyolefin is a polypropylene having a melt flow rate of from 12 to 24 g/10 min at 230° C. and 2.16 Kg (ASTM D1238-13 (2013)).

8. The composition of bi-component polymeric microfibers as claimed in claim 1, wherein the bi-component polymeric microfibers comprise a second component (core) to first component (shell) ratio of from 55 to 95 wt. % to 5 to 45 wt. % (or from 95:5 to 55:45), all weights based on the total weight of microfiber solids.

9. The composition of bi-component polymeric microfibers as claimed in claim 1, wherein the bi-component polymeric microfibers comprise a second component (core) to first component (shell) ratio of from 60 to 90 wt. % to from 10 to 40 wt. % (or from 60:40 to 90:10), all weights based on the total weight of microfiber solids.

10. The composition of bi-component polymeric microfibers as claimed in claim 1, wherein the composition comprises a wet fiber cement composition of the bi-component polymeric microfibers, and, further, comprises water, hydraulic cement, limestone aggregate and cellulosic fibers.
